(19) United States
(12) Patent Application Publication
(10) Pub. No.: US 2016/0293149 A1
(43) Pub. Date: Oct. 6, 2016

(54) Strapless Guitar Rest

(71) Applicant: Rodney Mael, Renton, WA (US)

(72) Inventor: Rodney Mael, Renton, WA (US)

(21) Appl. No.: 14/792,351

(22) Filed: Jul. 6, 2015

Related U.S. Application Data
(60) Provisional application No. 62/142,564, filed on Apr. 3, 2015.

(51) Int. Cl. G10G 5/00; G10D 1/08

(52) U.S. Cl. CPC G10G 5/005; G10D 1/08

(57) ABSTRACT

A strapless guitar rest includes a main rest shelf, a shelf base, and a grip cover. The main rest shelf provides a curved surface for supporting the curved portion of a guitar, while the shelf base provides a means for anchoring the strapless guitar rest to the user. The main rest shelf is adjacently connected to the shelf base and positioned at an offset angle in relation to the shelf base in order to compensate for displacement of the strapless guitar rest due to torque from the weight of the guitar. The main rest shelf includes a rest pad to further conform to the shape of the guitar and a shelf tab to prevent the guitar from falling off of the main rest shelf. The grip cover encompasses the main rest shelf, providing increased friction between the strapless guitar rest and the guitar.

The current application claims a priority to the U.S. Provisional Patent application Ser. No. 62/142,564 filed on Apr. 3, 2015.

### FIELD OF THE INVENTION

The present invention relates generally to guitar accessories. More specifically, the present invention is a strapless guitar rest that is a single piece unit used by a guitar player to support a guitar while playing.

### BACKGROUND OF THE INVENTION

The most commonly used item to support a guitar while playing, particularly while standing, is a strap that is placed over the shoulder and around the back of the user. The strap is attached to the guitar at both ends by a pair of strap buttons on the guitar. Such a setup results in the weight of the guitar being supported by the back and shoulders of the user. This can result is back and shoulder fatigue, especially when playing for extended periods of time, and is not ideal for individuals with back or shoulder problems. Furthermore, conventional guitar straps can be problematic in allowing the user to quickly set down the guitar. For example, a guitarist often has to change instruments during a song or performance and can often get tangled in conventional guitar straps when trying to quickly change instruments. For the amateur, it can be difficult to quickly set down the guitar in order to answer the phone, answer the door, adjust amplifiers or other equipment, etc. and then quickly pick the guitar back up and resume playing.

Therefore it is the object of the present invention to provide a strapless guitar rest that allows a user to quickly pickup and set down a guitar. The present invention provides a main rest shelf for supporting the guitar and a shelf base that is positioned into the pants, pocket, belt, etc. of the user. The main rest shelf has a curved surface on which the user can position the curved portion of the guitar in order to fully support the guitar. The placement of the present invention about the pants, pocket, or belt of the user alleviates stress to the shoulders and back of the user, allowing for a more comfortable playing experience. Additionally, as no straps are needed, the guitar can easily and quickly be placed on or removed from the main rest shelf. While the present invention provides a means for supporting the guitar without a strap, the present invention can also be used in conjunction with a strap in order to more evenly distribute the weight of the guitar throughout the entirety of the user's body.

### BRIEF DESCRIPTION OF THE DRAWINGS

FIG. 1 is a perspective view of the present invention, wherein the main rest shelf is curved downwards.

FIG. 2 is a front elevational view of the present invention, wherein the main rest shelf is curved downwards.

FIG. 3 is a right side elevational view of the present invention, wherein the main rest shelf is curved downwards.

FIG. 4 is a rear elevational view of the present invention, wherein the main rest shelf is curved downwards.

FIG. 5 is a perspective view of the present invention, wherein the grip cover is encompassing the main rest shelf.

FIG. 6 is a perspective view of the present invention, wherein the main rest shelf is curved upwards.

FIG. 7 is a front elevational view of the present invention, wherein the main rest shelf is curved upwards.

FIG. 8 is a right side elevational view of the present invention, wherein the main rest shelf is curved upwards.

FIG. 9 is a perspective view, wherein a guitar is rested upon the present invention.

### DETAIL DESCRIPTIONS OF THE INVENTION

All illustrations of the drawings are for the purpose of describing selected versions of the present invention and are not intended to limit the scope of the present invention.

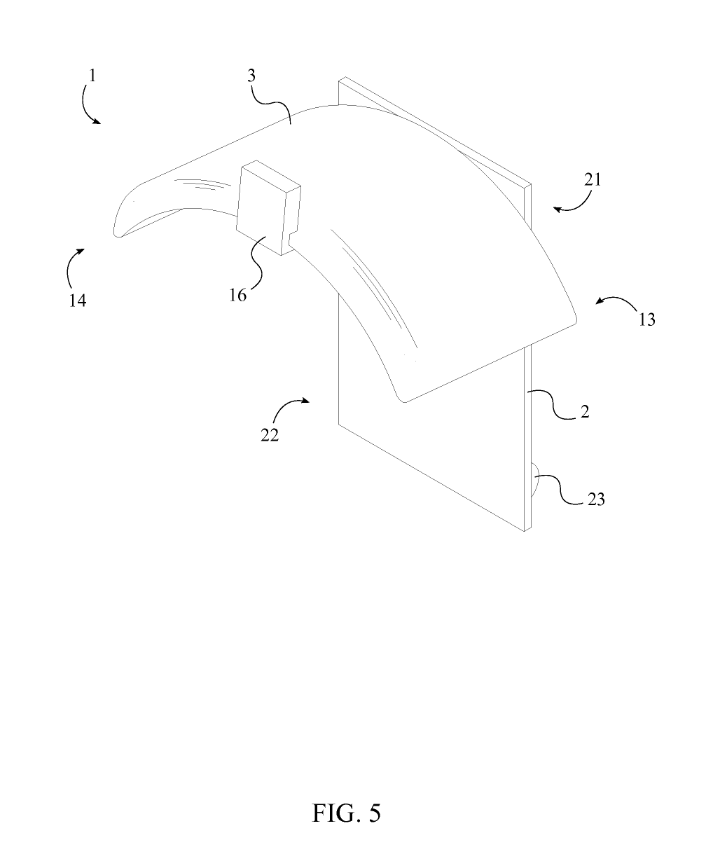

The present invention is a strapless guitar rest for supporting a guitar body. The strapless guitar rest is positioned within the pants, pockets, belt, etc. of a user, and provides a curved surface on which the guitar body can be rested. In reference to FIG. 5, the present invention comprises a main rest shelf 1, a shelf base 2, and a grip cover 3. The shelf base 2 is the portion of the present invention that is positioned within the pants, pockets, or belt of the user, while the main rest shelf 1 supports the guitar body. The grip cover 3 encompasses the main rest shelf 1 and provides a layer to protect the guitar body from being scratched, as well as increases the friction between the guitar body and the present invention to prevent the guitar body from slipping off.

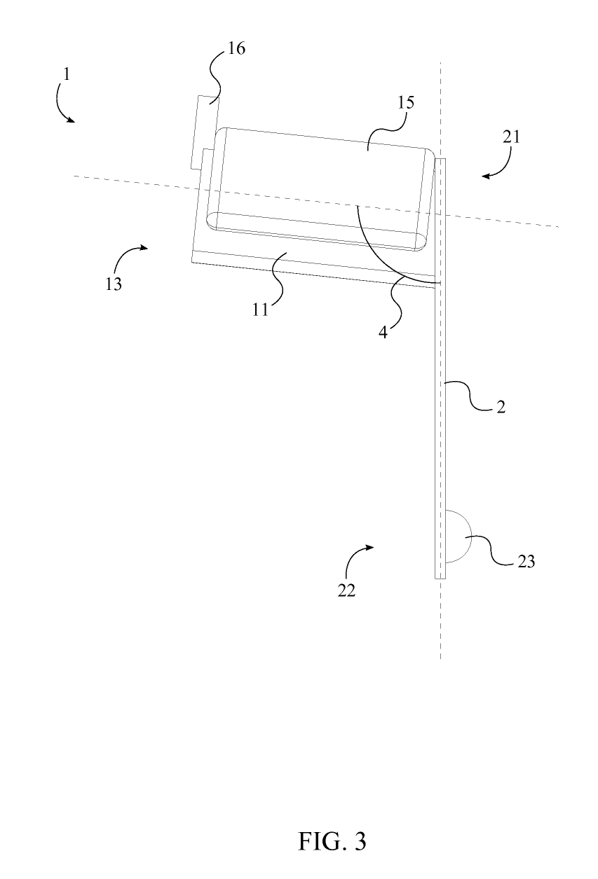

In reference to FIG. 3, the shelf base 2 is a flat, elongated member that is used to anchor the present invention to the user. The shelf base 2 comprises a proximal end 21 and a distal end 22; the proximal end 21 and the distal end 22 are positioned opposite each other along the shelf base 2. The main rest shelf 1 is adjacently connected to the shelf base 2 and is positioned adjacent to the proximal end 21. The distal end 22 is positioned into the pants, pocket, or belt of the user, while the proximal end 21 and the main shelf rest protrude upwards, above the pants, pocket, or belt. When weight is applied to the main rest shelf 1 (i.e. the guitar body is positioned on the main rest shelf 1), the resulting torque presses the distal end 22 in against the user's leg, preventing the main rest shelf 1 from tilting forward and causing the guitar body to fall off. The main rest shelf 1 is supported by the edge of the user's pants, pocket, or belt, preventing the main rest shelf 1 from moving downwards.

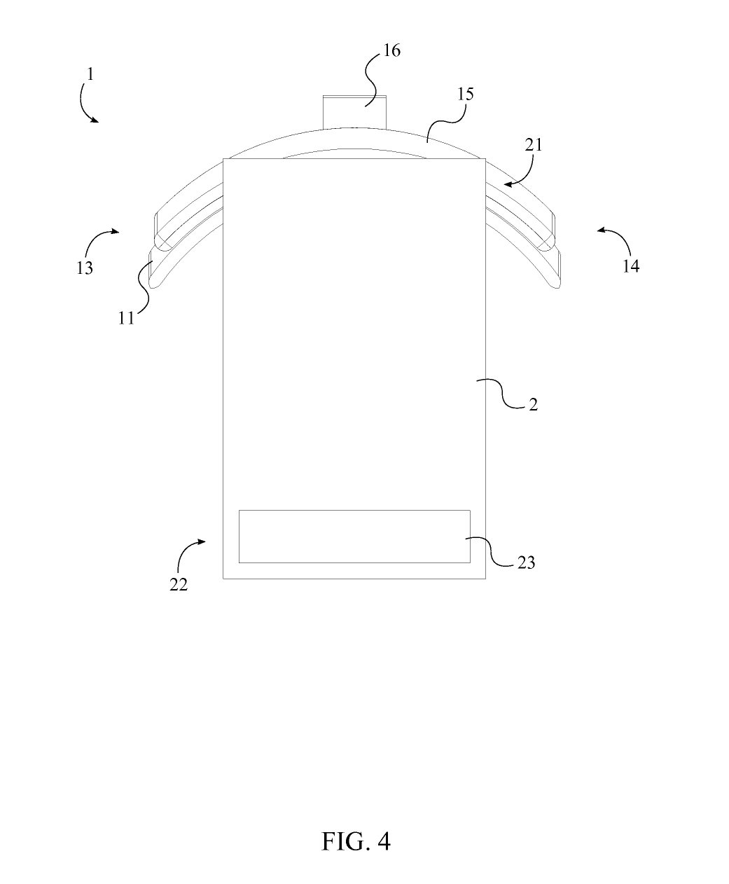

In reference to FIG. 3-4, the shelf base 2 further comprises a under pad 23. The under pad 23 is positioned adjacent to the distal end 22 and is positioned opposite the main rest shelf 1 about the shelf base 2. In this way, the under pad 23 is positioned adjacent to the user's leg when the distal end 22 of the shelf base 2 is positioned into the pants, pocket, or belt of the user; the under pad 23 is directed towards the user's body, while the main rest shelf 1 is directed away from the user's body. The under pad 23 helps to prevent the shelf base 2 from sagging while the guitar body is positioned on the main rest shelf 1. Additionally, the under pad 23 provides a comfortable surface for when pressure is placed on the user's body through the weight of the guitar on the main rest shelf 1. The under pad 23 prevents the distal end 22 from digging into the leg of the user, creating a buffer between the shelf base 2 and the leg of the user.

In the preferred embodiment of the present invention, the under pad 23 is constructed from layered soft felt and covered in a layer of leather. This provides a soft pliable body for comfort, while also increasing the friction between the shelf base 2 and the user's leg. It is also possible for the under pad 23 to be constructed from any other type of materials in other embodiments of the present invention.

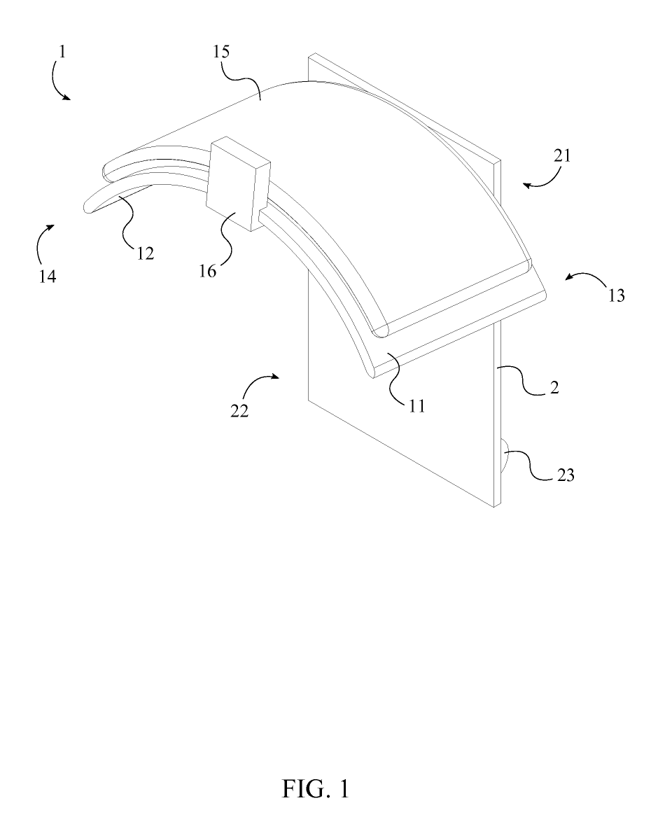

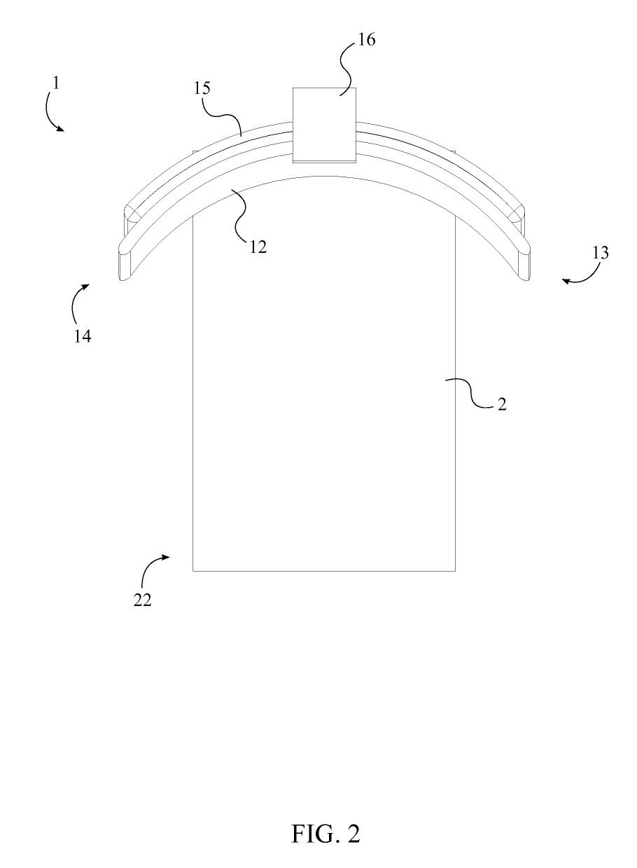

In reference to FIG. 1-2, the main rest shelf 1 is a curved structure that is used to support the guitar body and comprises a first surface 11, a second surface 12, a first terminal end 13, a second terminal end 14, a rest pad 15, and a shelf tab 16. The first terminal end 13 and the second terminal end 14 are positioned opposite each other along the main rest shelf 1, while the first surface 11 and the second surface 12 are positioned opposite each other about the main rest shelf 1. The first surface 11 is concavely contoured from the first terminal end 13 to the second terminal end 14, while the second surface 12 is convexly contoured from the first terminal end 13 to the second terminal end 14. Furthermore, the first surface 11 and the second surface 12 are concentric. Resultantly, the main rest shelf 1 is a thin, curved member that is mounted to the shelf base 2.

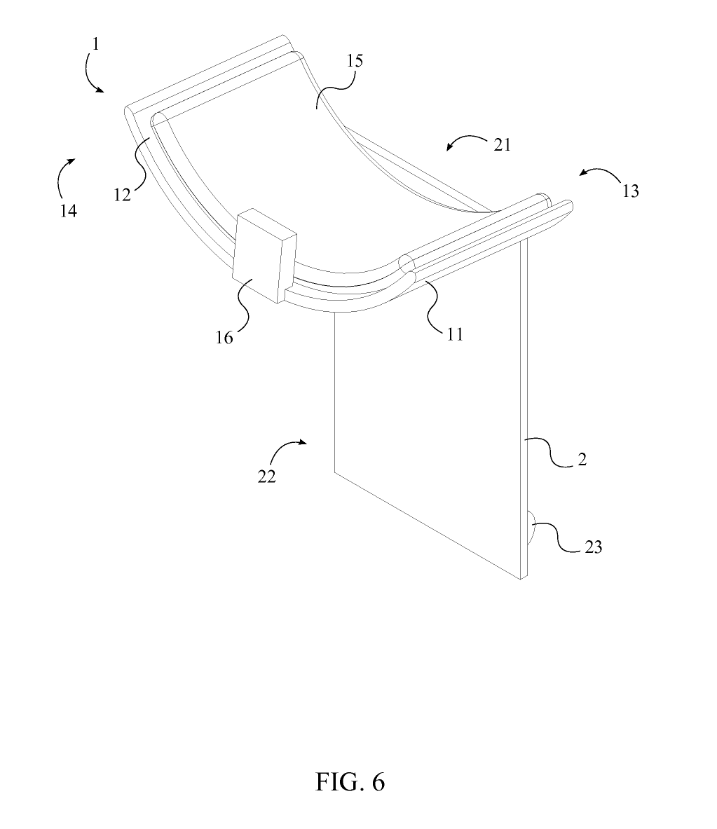

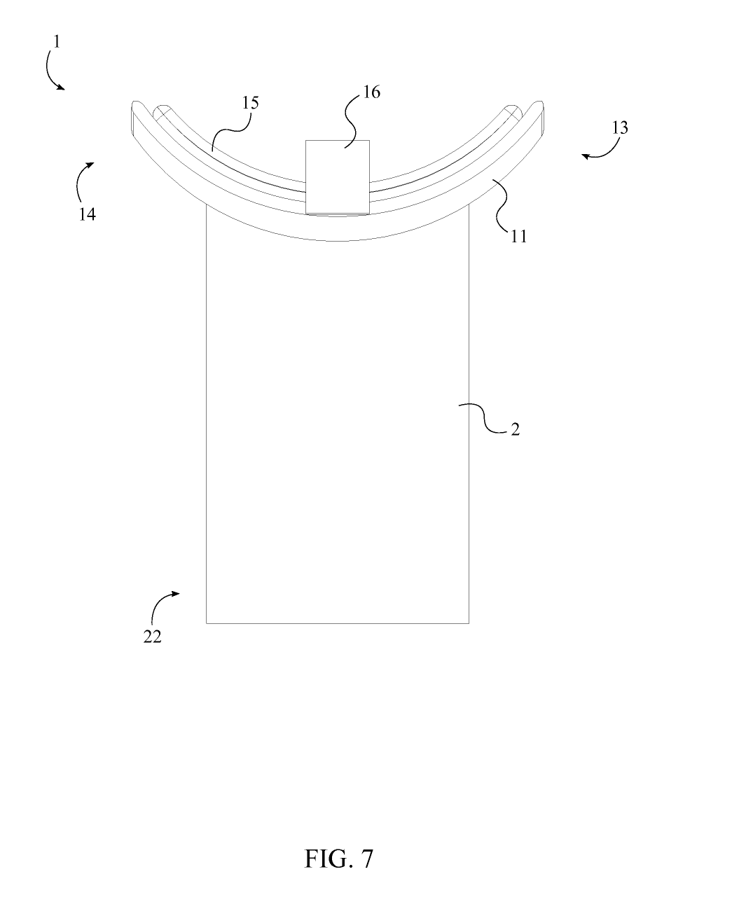

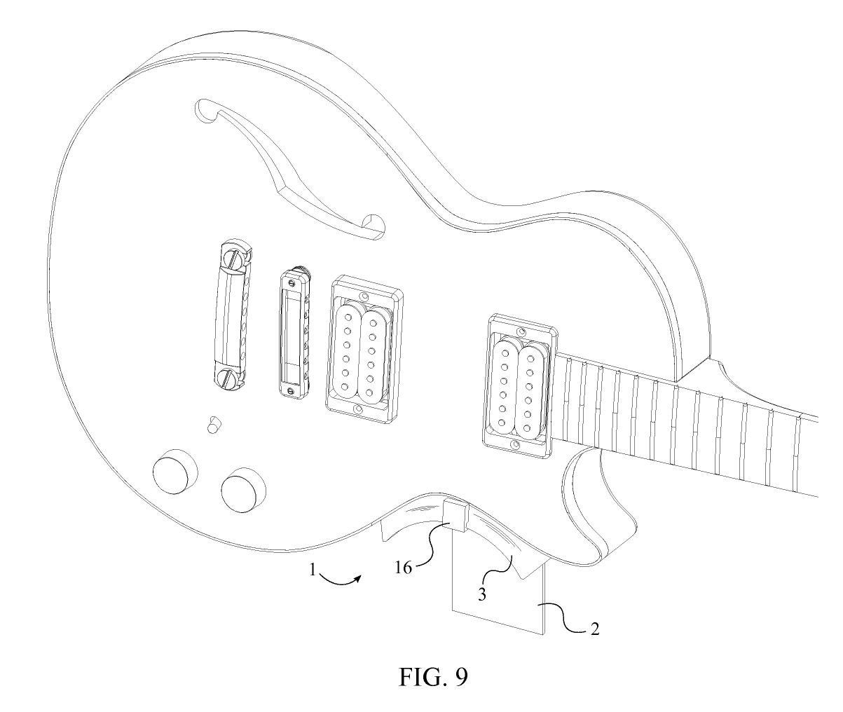

The main rest shelf 1 can be oriented in two different ways in relation to the shelf base 2. The first surface 11 and the second surface 12 can be curved towards the distal end 22 of the shelf base 2 as shown in FIG. 1-2, or curved away from the distal end 22 of the shelf base 2 as shown in FIG. 6-7. The orientation of the main rest shelf 1 is dependent on the desired location of support for the guitar body. If the main rest shelf 1 is curved downwards, then the present invention is designed to support the guitar body in between the upper bout and the lower bout of the guitar, as depicted in FIG. 9. If the main rest shelf 1 is curved upwards, then the present invention is designed to support the guitar body by either the upper bout or the lower bout.

The rest pad 15 provides a cushioned support that allows the present invention to conform to various guitar shapes. Not all guitars have the same body shape, and as such the curvature of the main rest shelf 1 may not precisely match the curvature of every guitar. The rest pad 15 provides a pliable material that is able to conform to the shape of the guitar in order to adequately support guitars having different curvatures. Furthermore, the rest pad 15 can be reshaped allowing the present invention to constantly be reused with different guitars. Preferably the rest pad 15 is a thin gel pack or a piece of memory foam, however, it is possible for the rest pad 15 to be constructed from any other material(s) having similar properties.

The rest pad 15 is positioned on either the first surface 11 or the second surface 12, depending on the curvature of the main rest shelf 1. If the first surface 11 and the second surface 12 are curved towards the distal end 22 (i.e. downwards), then the rest pad 15 is positioned on the first surface 11 as shown in FIG. 1, wherein the rest pad 15 is positioned on the top of the main rest shelf 1. If the first surface 11 and the second surface 12 are curved away from the distal end 22 (i.e. upwards), then the rest pad 15 is positioned on the second surface 12 as shown in FIG. 6, wherein the rest pad 15 is positioned on the top of the main rest shelf 1. In essence, the rest pad 15 is positioned about the main rest shelf 1 opposite the distal end 22, no matter the curvature of the main rest shelf 1.

The shelf tab 16 is used to further secure the guitar body on the main rest shelf 1, preventing the guitar body from sliding away from the user's body and off of the main rest shelf 1. In reference to FIG. 1, the shelf tab 16 is an extrusion that is positioned in between the first terminal end 13 and the second terminal end 14; preferably centrally along the main rest shelf 1. Furthermore, the shelf tab 16 is positioned across the first surface 11 and the second surface 12 opposite the shelf base 2, wherein the rest pad 15 is positioned in between the shelf tab 16 and the shelf base 2. The shelf tab 16 extends upwards, away from the distal end 22 of the shelf base 2 in order to prevent the guitar body from sliding forward, off of the present invention.

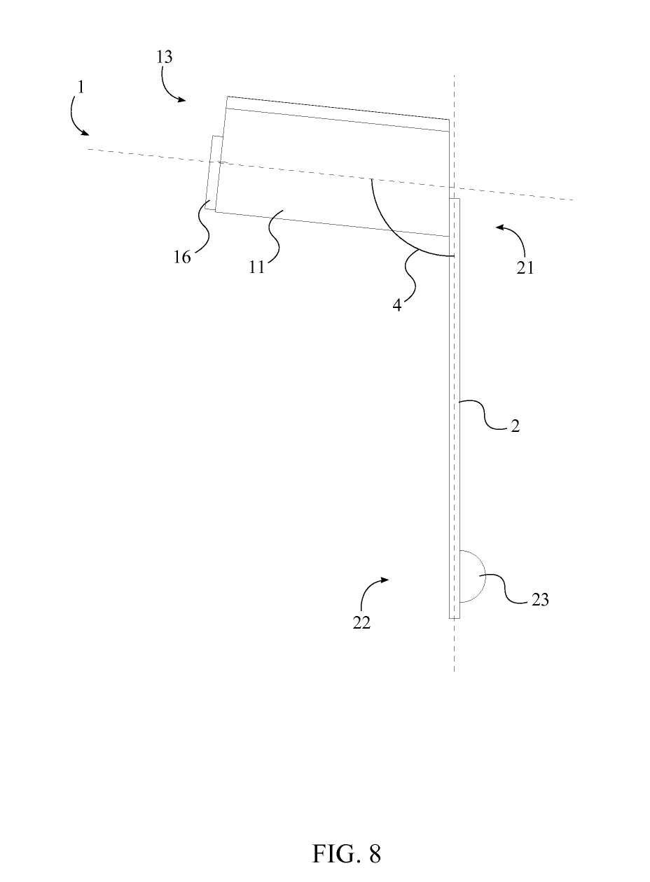

Additionally, the main rest shelf 1 is positioned at an offset angle 4 in relation to the shelf base 2. In reference to FIG. 3 and FIG. 8, the offset angle 4 is an obtuse angle, wherein the main rest shelf 1 is angles upwards when the present invention is positioned within the pants, pocket, or belt of the user. The offset angle 4 compensates for the displacement of the present invention when the guitar body is positioned on the main rest shelf 1. When the guitar body is placed on the main rest shelf 1, the weight of the guitar produces torque on the present invention, wherein the main rest shelf 1 is displaced away from the user. If the main rest shelf 1 was oriented perpendicular or at an acute angle in relation to the shelf base 2, then the main rest shelf 1 would be angled downwards due to the weight of the guitar, allowing the guitar to easily slide off. Therefore, it is the object of the offset angle 4 to compensate for the downward displacement of the main rest shelf 1, allowing the main rest shelf 1 to remain perpendicular or at an upwards angle in relation to the user's body when under the weight of the guitar.

In reference to FIG. 5, the grip cover 3 is bonded to and encompasses the main rest shelf 1, providing a surface that protects the guitar body from being scratched and increases the friction between the guitar body and the present invention to prevent the guitar body from slipping. The grip cover 3 may fully or partially encompass the main rest shelf 1 depending on the embodiment of the present invention. Furthermore, the grip cover 3 is form fitting, while allowing the rest pad 15 enough flexibility to conform to guitar curve contact points. Preferably the grip cover 3 is a leather or pleather material, however, it is possible for any other type of material to be used for the grip cover 3.

In an alternative embodiment of the present invention, the main rest shelf 1 is hingedly connected to the shelf base 2, wherein the main rest shelf 1 can be folded in order to offer a more compact state. This allows the present invention to be more readily stored or transported when not in use. The main rest shelf 1 should be made to fold towards the proximal end 21 of the shelf base 2, such that the main rest shelf 1 is capable of supporting the weight of the guitar body when unfolded.

Although the invention has been explained in relation to its preferred embodiment, it is to be understood that many other possible modifications and variations can be made without departing from the spirit and scope of the invention as hereinafter claimed.

1. A strapless guitar rest comprises:
a main rest shelf;
a shelf base;
the main rest shelf comprises a first surface, a second surface, a first terminal end, and a second terminal end;
the shelf base comprises a proximal end and a distal end;
the proximal end and the distal end being positioned opposite each other along the shelf base;
the first terminal end and the second terminal end being positioned opposite each other along the main rest shelf;
the first surface being convexly contoured from the first terminal end to the second terminal end;
the second surface being concavely contoured from the first terminal end to the second terminal end;
the first surface and the second surface being concentric;
the main rest shelf being adjacently connected to the shelf base;
the main rest shelf being positioned adjacent to the proximal end;
a grip cover;
the grip cover encompassing the main rest shelf;
the shelf base comprises a under pad;
the under pad being positioned adjacent to the distal end;
the under pad being positioned opposite the main rest shelf about the shelf base; and
the main rest shelf being positioned at an offset angle in relation to the shelf base.

2. The strapless guitar rest as claimed in claim 1 comprises:
the first surface and the second surface being curved towards the distal end.

3. The strapless guitar rest as claimed in claim 1 comprises:
the first surface and the second surface being curved away from the distal end.

4. (canceled)

5. (canceled)

6. The strapless guitar rest as claimed in claim 1 comprises:
the main rest shelf comprises a rest pad;
the rest pad being positioned on the first surface; and
the first surface being curved towards the distal end.

7. The strapless guitar rest as claimed in claim 1 comprises:
the main rest shelf comprises a rest pad;
the rest pad being positioned on the second surface; and
the second surface being curved away from the distal end.

8. The strapless guitar rest as claimed in claim 1 comprises:
the main rest shelf comprises a shelf tab;
the shelf tab being positioned across the first surface and the second surface opposite the shelf base; and
the shelf tab being positioned in between the first terminal end and the second terminal end.

9. (canceled)

10. A strapless guitar rest comprises:
a main rest shelf;
a shelf base;
the main rest shelf comprises a first surface, a first terminal end, and a second terminal end;
the shelf base comprises a proximal end and a distal end;
the proximal end and the distal end being positioned opposite each other along the shelf base;
the first terminal end and the second terminal end being positioned opposite each other along the main rest shelf;
the first surface being convexly contoured from the first terminal end to the second terminal end;
the first surface being curved towards the distal end;
the main rest shelf being adjacently connected to the shelf base;
the main rest shelf being positioned at an offset angle in relation to the shelf base;
the main rest shelf being positioned adjacent to the proximal end;
a grip cover; and
the grip cover encompassing the main rest shelf.

11. (canceled)

12. The strapless guitar rest as claimed in claim 10 comprises:
the shelf base comprises a under pad;
the under pad being positioned adjacent to the distal end; and
the under pad being positioned opposite the main rest shelf about the shelf base.

13. The strapless guitar rest as claimed in claim 10 comprises:
the main rest shelf comprises a rest pad; and
the rest pad being positioned on the first surface.

14. The strapless guitar rest as claimed in claim 10 comprises:
the main rest shelf comprises a shelf tab;
the shelf tab being positioned across the first surface opposite the shelf base; and
the shelf tab being positioned in between the first terminal end and the second terminal end.

15. A strapless guitar rest comprises:
a main rest shelf;
a shelf base;
the main rest shelf comprises a second surface, a first terminal end, and a second terminal end;
the shelf base comprises a proximal end and a distal end;
the proximal end and the distal end being positioned opposite each other along the shelf base;
the first terminal end and the second terminal end being positioned opposite each other along the main rest shelf;
the second surface being concavely contoured from the first terminal end to the second terminal end;
the second surface being curved away from the distal end;
the main rest shelf being adjacently connected to the shelf base;
the main rest shelf being positioned at an offset angle in relation to the shelf base;
the main rest shelf being positioned adjacent to the proximal end;
the main rest shelf comprises a shelf tab;
the shelf tab being positioned across the second surface opposite the shelf base; and
the shelf tab being positioned in between the first terminal end and the second terminal end.

16. The strapless guitar rest as claimed in claim 15 comprises:
a grip cover; and
the grip cover encompassing the main rest shelf.

17. The strapless guitar rest as claimed in claim 15 comprises:
the shelf base comprises a under pad;
the under pad being positioned adjacent to the distal end; and
the under pad being positioned opposite the main rest shelf about the shelf base.

18. The strapless guitar rest as claimed in claim 15 comprises:
the main rest shelf comprises a rest pad; and
the rest pad being positioned on the second surface.

19. (canceled)
